(19) United States
(12) Patent Application Publication
(10) Pub. No.: US 2024/0311989 A1
(43) Pub. Date: Sep. 19, 2024

(54) ABNORMALITY JUDGMENT DEVICE, ABNORMALITY JUDGMENT METHOD, AND ABNORMALITY JUDGMENT PROGRAM

(71) Applicant: NIPPON TELEGRAPH AND TELEPHONE CORPORATION, Tokyo (JP)

(72) Inventors: Motohiro TAKAGI, Tokyo (JP); Kazuya YOKOHARI, Tokyo (JP); Masaki KITAHARA, Tokyo (JP); Jun SHIMAMURA, Tokyo (JP)

(73) Assignee: NIPPON TELEGRAPH AND TELEPHONE CORPORATION, Tokyo (JP)

(21) Appl. No.: 18/574,737

(22) PCT Filed: Jun. 29, 2021
(86) PCT No.: PCT/JP2021/024476

§ 371 Date: Dec. 27, 2023

(51) Int. Cl. G06T 7/00; G06T 7/246; G06V 20/40; G06V 40/20

(52) U.S. Cl. CPC G06T 7/0002; G06T 7/246; G06V 20/41; G06V 40/20; G06T 2207/10016; G06T 2207/20081; G06T 2207/30196

(57) ABSTRACT

A motion abnormality determination unit 62 classifies video data representing a motion of a person into motion clusters and determines whether the motion of the person is abnormal. A procedure classification unit 66 classifies the motion of the person into procedures based on classification results of the motion clusters and a procedure tree. A procedure abnormality determination unit 68 determines whether the procedure including the motion of the person is abnormal based on the classification result of the procedure.

### TECHNICAL FIELD

The technology of the present disclosure relates to an abnormality determination device, an abnormality determination method, and an abnormality determination program.

### BACKGROUND ART

In recent years, with the spread of high-definition cameras, there has been an increasing need for a technique for analyzing a motion of a person with a captured image. For example, the technique is for detecting a criminal motion by a monitoring camera, detection of a dangerous motion at a construction site, and the like. To discover these motions, it is necessary to look at a large amount of video footage. A person who understands the definition of an abnormal motion observes the motion in the video to detect an abnormal motion. However, since manual detection is time- and labor-intensive, a method of detecting an abnormal motion by constructing an algorithm for automatic detection is conceivable.

In recent years, a technique for detecting an abnormal motion using a neural network has been proposed (Non Patent Literature 1). In the method of Non Patent Literature 1, abnormal behavior is detected with high accuracy by clustering videos.

### CITATION LIST

### Non Patent Literature

Non Patent Literature 1: Zaheer M. Z., Mahmood A., Astrid M., Lee SI. CLAWS: Clustering Assisted Weakly Supervised Learning with Normalcy Suppression for Anomalous Event Detection. ECCV 2020.

### SUMMARY OF INVENTION

### Technical Problem

In the conventional method for detecting an abnormal motion in a video shown in Non Patent Literature 1, a procedure and a motion are not clearly distinguished. Therefore, for example, in a case where there are procedures of (Procedure 1) erecting a stepladder on the floor, (Procedure 2) tightening a safety belt, and (Procedure 3) ascending the stepladder, there are many motions in each procedure, and it is difficult to determine whether the order of the procedures is correct. Specifically, in Procedure 1, there are many motions in which the person bends the knee, grasps the stepladder, and lifts and fixes the stepladder. Similarly to climbing the stepladder, the procedure of tightening the safety belt in Procedure 2 also includes a series of motions of holding the safety belt and fixing the safety belt to the human body. Procedure 3 includes a number of motions: walking toward the stepladder, stepping on the steps, and climbing with the stepladder held with the hands. As described above, it is necessary to ascertain the motions as a procedure collectively to some extent and confirm whether the order of the procedures is correct. However, in the current abnormal motion detection method, abnormality detection of individual motions is mainly performed, and abnormality detection of a procedure in which a plurality of motions are integrated has not been studied. Therefore, if the timing at which the safety belt is fastened is after climbing the stepladder, it is difficult to detect a motion that is dangerous from the image. In addition, since it is also necessary to detect abnormality of the motion itself in the procedure, a method considering simultaneous detection of these is required.

The disclosed technology has been made in view of the above points, and an object thereof is to provide an abnormality determination device, a method, and a program capable of accurately determining an abnormality of a procedure and an abnormality of a motion itself.

### Solution to Problem

A first aspect of the present disclosure is an abnormality determination device including a clustering database that stores a plurality of motion clusters related to a motion of a person based on features of video data, a procedure tree database that stores a procedure tree representing a relationship between a plurality of procedures including at least one motion, the procedure tree storing the motion clusters for each of the plurality of procedures, a motion abnormality determination unit that classifies video data representing a motion of a person into the motion clusters and determines whether the motion of the person is abnormal, a procedure classification unit that classifies the motion of the person into the procedures based on classification results of the motion clusters and the procedure tree, and a procedure abnormality determination unit that determines whether the procedure including the motion of the person is abnormal based on classification results of the procedure.

A second aspect of the present disclosure is an abnormality determination method in an abnormality determination device including a clustering database that stores a plurality of motion clusters related to a motion of a person based on features of video data, and a procedure tree database that stores a procedure tree representing a relationship between a plurality of procedures including at least one motion, the procedure tree storing the motion clusters for each of the plurality of procedures, the method including causing a motion abnormality determination unit to classify video data representing a motion of a person into the motion clusters and determine whether the motion of the person is abnormal, causing a procedure classification unit to classify the motion of the person into the procedures based on classification results of the motion clusters and the procedure tree, and causing a procedure abnormality determination unit to determine whether the procedure including the motion of the person is abnormal based on classification results of the procedure.

A third aspect of the present disclosure is an abnormality determination program for causing a computer to function as the abnormality determination device of the first aspect.

### Advantageous Effects of Invention

According to the disclosed technology, it is possible to accurately determine abnormality of a procedure and abnormality of a motion itself.

### BRIEF DESCRIPTION OF DRAWINGS

FIG. 1 is a schematic block diagram of an example of a computer functioning as a learning device and an abnormality determination device according to a first embodiment and a second embodiment.

FIG. 2 is a block diagram illustrating a configuration of the learning device according to the first embodiment and the second embodiment.

FIG. 3 is a block diagram illustrating a configuration of the abnormality determination device according to the first embodiment and the second embodiment.

FIG. 4 is a flowchart illustrating a clustering processing routine of the learning device according to the first embodiment.

FIG. 5 is a flowchart illustrating a motion abnormality determination model learning processing routine of the learning device according to the first embodiment.

FIG. 6 is a flowchart illustrating a procedure tree construction processing routine of the learning device according to the first embodiment.

FIG. 7 is a flowchart illustrating an abnormality determination processing routine of the abnormality determination device according to the first embodiment.

FIG. 8 is a flowchart illustrating a flow of processing of the motion abnormality determination unit of the abnormality determination device according to the first embodiment.

FIG. 9 is a flowchart illustrating a flow of processing of a procedure classification unit of the abnormality determination device according to the first embodiment.

FIG. 10 is a flowchart illustrating a flow of processing of the procedure abnormality determination unit of the abnormality determination device according to the first embodiment.

### DESCRIPTION OF EMBODIMENTS

Hereinafter, an example of an embodiment of the disclosed technology will be described with reference to the drawings. In the drawings, the same or equivalent components and parts will be denoted by the same reference signs. In addition, dimensional ratios in the drawings are exaggerated for convenience of description, and may be different from actual ratios.

### First Embodiment

### Overview of Present Embodiment

In the present embodiment, a motion abnormality label and a motion class probability are output using clustering information obtained by clustering a video segment obtained by dividing video data and a video feature of the video segment as inputs, a procedure probability is output using the motion class probability and a procedure tree as inputs, and a procedure abnormality label is output using the procedure probability as an input.

Here, the procedure includes not only a manually defined procedure such as a procedure statement but also a pseudo procedure in which at least one motion is collected. One procedure includes at least one motion.

### Configuration of Learning Device According to Present Embodiment

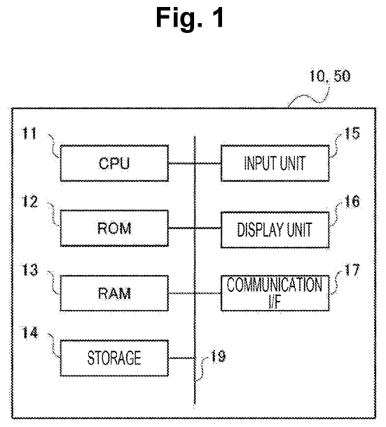

FIG. 1 is a block diagram showing a hardware configuration of a learning device 10 according to the present embodiment.

As illustrated in FIG. 1, the learning device 10 includes a central processing unit (CPU) 11, a read only memory (ROM) 12, a random access memory (RAM) 13, a storage 14, an input unit 15, a display unit 16, and a communication interface (I/F) 17. The components are communicatively connected to each other via a bus 19.

The CPU 11 is a central processing unit, and executes various programs and controls each unit. That is, the CPU 11 reads the programs from the ROM 12 or the storage 14 and executes the programs by using the RAM 13 as a work area. The CPU 11 performs control of each of the above-described components and various types of operation processing according to a program stored in the ROM 12 or the storage 14. In the present embodiment, a learning program is stored in the ROM 12 or the storage 14. The learning program may be one program or a group of programs including a plurality of programs or modules.

The ROM 12 stores various programs and various types of data. The RAM 13 temporarily stores a program or data as a working area. The storage 14 includes a hard disk drive (HDD) or a solid state drive (SSD) and stores various programs including an operating system and various types of data.

The input unit 15 includes a pointing device such as a mouse and a keyboard and is used to perform various inputs.

The input unit 15 receives learning video data as an input. Specifically, the input unit 15 receives learning video data indicating at least one motion. A label indicating whether the motion itself is abnormal or normal is given to the learning video data.

The display unit 16 is, for example, a liquid crystal display and displays various types of information. The display unit 16 may function as the input unit 15 by employing a touchscreen system.

The communication interface 17 is an interface for communicating with another device, and for example, standards such as Ethernet (registered trademark), FDDI, and Wi-Fi (registered trademark) are used.

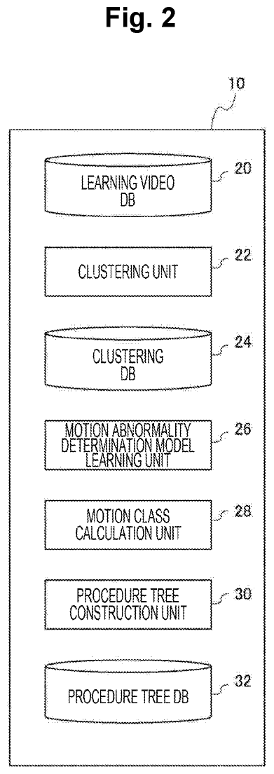

Next, functional configurations of the learning device 10 will be described. FIG. 2 is a block diagram illustrating an example of a functional configuration of the learning device 10.

As illustrated in FIG. 2, the learning device 10 functionally includes a learning video database (DB) 20, a clustering unit 22, a clustering database (DB) 24, a motion abnormality determination model learning unit 26, a motion class calculation unit 28, a procedure tree construction unit 30, and a procedure tree database (DB) 32.

The learning video database 20 stores a plurality of pieces of input learning video data. The learning video data may be input for each video, may be input for each divided video segment, or may be input for each video frame. Here, the video segment is a unit in which a video is collectively divided into a plurality of frames, and is, for example, a unit in which 32 frames are defined as one segment.

The clustering unit 22 receives the learning video segment group stored in the learning video database 20 as an input, clusters the learning video segment group based on the feature of the video data, and outputs clustering information representing a plurality of motion clusters related to the motion of the person. The feature of the video data is a feature vector extracted in advance from the video segment of the learning video data. The clustering information is stored in the clustering database 24. When the number of motion clusters is K, the clustering information is a center vector of a feature vector of each of the K motion clusters. In addition, the clustering unit 22 stores a motion cluster to which each video segment belongs in the clustering database 24 as a clustering result for the learning video segment group.

The motion abnormality determination model learning unit 26 extracts a learning video segment group from the learning video database 20, classifies video data representing a motion of a person into motion clusters, and learns a motion abnormality determination model for determining whether the motion of the person itself is abnormal. Here, a machine learning model such as a neural network is used as the motion abnormality determination model. In addition, the time series order of each video is held in the learning video segment group. A label indicating whether each learning video segment is abnormal or normal is applied to each learning video segment, and the motion abnormality determination model learning unit 26 learns the motion abnormality determination model so as to reduce a loss with respect to the label and a clustering result for the learning video segment group.

Using the learning video segment group stored in the learning video database 20 and the clustering information stored in the clustering database 24 as inputs, the motion class calculation unit 28 calculates, for each learning video segment, a motion class probability that is a probability belonging of to each of the plurality of motion clusters. Specifically, for each learning video segment, the motion class calculation unit 28 compares the feature of the video with the center vectors of the feature vectors of the K motion clusters, and calculates a motion class probability which is a probability belonging to each of the plurality of motion clusters. When the number of motion clusters is K, the motion class probability is a K-dimensional vector, and the sum of the respective elements of the vector is 1.

The procedure tree construction unit 30 outputs a procedure tree with the motion class probability for each learning video segment as an input. Here, the procedure tree is a perspective tree representing a relationship between a plurality of procedures including at least one motion, and is a tree storing a motion cluster for each of the plurality of procedures. Specifically, based on the motion class probability for each learning video segment, a procedure is divided into groups of motions represented by the learning video segment, a procedure relationship is obtained, and a motion class probability corresponding to a procedure represented by a terminal node is calculated for each terminal node of a procedure tree representing the obtained procedure relationship, thereby constructing the procedure tree.

The constructed procedure tree is stored in the procedure tree database 32.

### Configuration of Abnormality Determination Device According to First Embodiment

FIG. 1 is a block diagram illustrating a hardware configuration of an abnormality determination device 50 according to the first embodiment.

As illustrated in FIG. 1, the abnormality determination device 50 has a configuration similar to that of the learning device 10, and an abnormality determination program for determining an abnormal motion is stored in the ROM 12 or the storage 14.

The input unit 15 receives video data representing a motion of a person as an input.

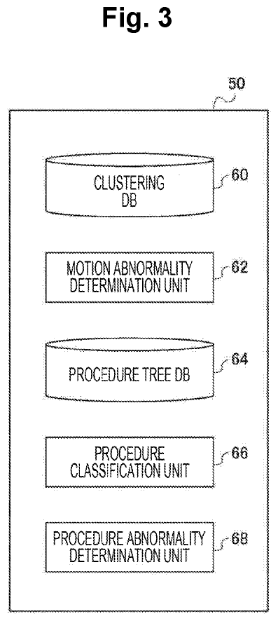

Next, a functional configuration of the abnormality determination device 50 will be described. FIG. 3 is a block diagram illustrating an example of a functional configuration of the abnormality determination device 50.

As illustrated in FIG. 3, the abnormality determination device 50 functionally includes a clustering database (DB) 60, a motion abnormality determination unit 62, a procedure tree database (DB) 64, a procedure classification unit 66, and a procedure abnormality determination unit 68.

Similarly to the clustering database 24, the clustering database 60 stores clustering information representing a plurality of motion clusters related to a motion of a person based on features of video data.

Using the motion abnormality determination model learned by the learning device 10, the motion abnormality determination unit 62 classifies the video data representing the motion of the person into the motion clusters for each time, and determines whether the motion of the person is abnormal.

Specifically, the motion abnormality determination unit 62 receives the video segment obtained by dividing the video data and the clustering information obtained by clustering the video features as inputs, and outputs the motion abnormality label and the motion class probability which is the probability belonging to each of the plurality of motion clusters using the motion abnormality determination model. The motion abnormality label indicates whether the motion itself in the input video segment is abnormal or normal by 1 or 0. In the present embodiment, in a case where the motion abnormality label is 1, it indicates that the motion itself is abnormal.

The procedure tree database 64 stores procedure trees similarly to the procedure tree database 32.

The procedure classification unit 66 classifies the motion represented by the video data into a procedure based on the classification result of the motion clusters and the procedure tree for each time. Specifically, the procedure classification unit 66 outputs a procedure probability that is a probability belonging to each of the plurality of procedures based on the motion class probability and the procedure tree for each time. For example, the procedure tree outputs the procedure probability at time t with the motion class probability up to time t as an input. Therefore, the procedure classification unit 66 holds the motion class probability at each time from the start of input of the video data.

The procedure abnormality determination unit 68 determines whether the procedure including the motion represented by the video segment is abnormal based on the classification result of the procedure at each time. Specifically, a procedure abnormality label indicating whether the procedure including the motion represented by the video segment is abnormal is output based on the procedure probability at each time. The procedure abnormality label takes 1 or 0 similarly to the motion abnormality label.

### Operation of Learning Device According to First Embodiment

Next, an operation of the learning device 10 according to the first embodiment will be described.

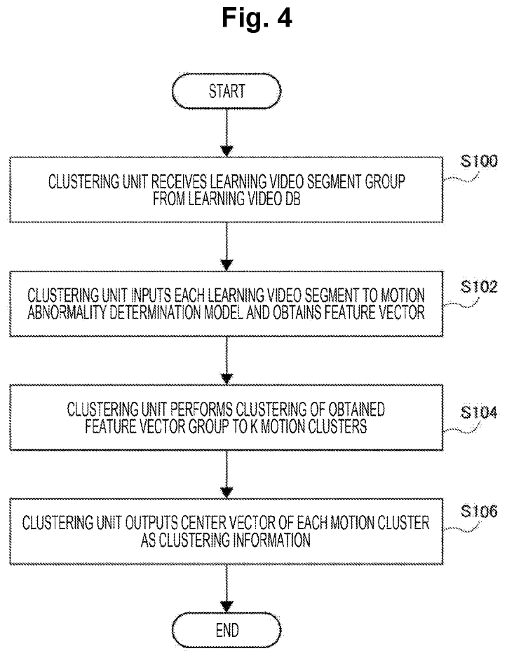

FIG. 4 is a flowchart illustrating a flow of clustering processing by the learning device 10. The CPU 11 reads the learning program from the ROM 12 or the storage 14, develops the learning program in the RAM 13, and executes the learning program, thereby performing clustering processing of constructing a cluster for expressing the motion class probability. Furthermore, a plurality of pieces of video data for learning is input to the learning device 10 and stored in the learning video database 20.

In step S100, the CPU 11 receives the learning video segment group from the learning video database 20 as the clustering unit 22.

In step S102, the CPU 11 inputs, as the clustering unit 22, each learning video segment to the motion abnormality determination model obtained by the preliminary learning, and obtains a feature vector.

In step S104, the CPU 11 performs clustering to classify the feature vector group obtained for each learning video segment into K motion clusters as the clustering unit 22.

In step S106, the CPU 11 outputs, as the clustering unit 22, the center vectors of the feature vectors of the respective motion clusters as clustering information, and stores the clustering information in the clustering database 24.

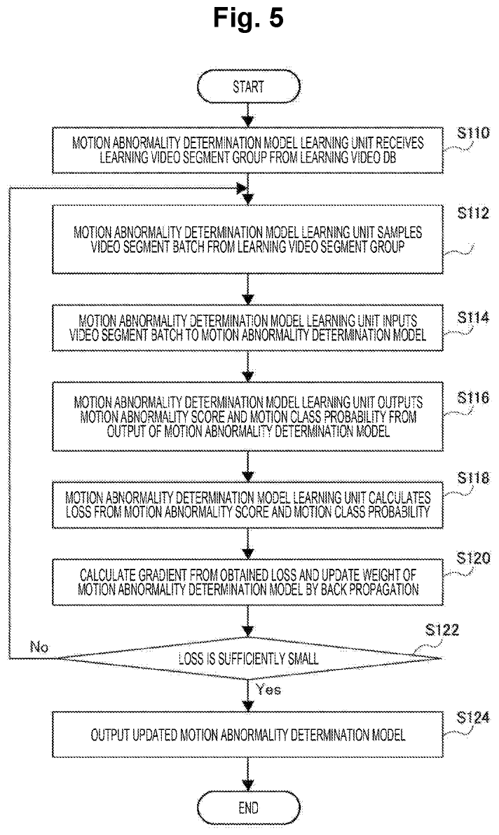

FIG. 5 is a flowchart illustrating a flow of a motion abnormality determination model learning processing by the learning device 10. Learning processing is performed by the CPU 11 reading a learning program from the ROM 12 or the storage 14, developing the learning program in the RAM 13, and executing the motion abnormality determination model learning processing. The flow of the motion abnormality determination model learning processing is similar to batch learning of a general neural network.

In step S110, the CPU 11 receives the learning video segment group from the learning video database 20 as the motion abnormality determination model learning unit 26.

In step S112, the CPU 11 samples the learning video segment batch from the learning video segment group as the motion abnormality determination model learning unit 26.

In step S114, the CPU 11 inputs each learning video segment included in the learning video segment batch to the motion abnormality determination model as the motion abnormality determination model learning unit 26.

In step S116, the CPU 11 obtains the motion abnormality score and the motion class probability from the output of the motion abnormality determination model for each learning video segment as the motion abnormality determination model learning unit 26.

In step S118, the CPU 11, as the motion abnormality determination model learning unit 26, calculates a loss from the motion abnormality score and the motion class probability for each learning video segment. Specifically, the loss is calculated by comparing the motion abnormality label and the clustering result applied to each learning video segment with the motion abnormality score and the motion class probability for each learning video segment.

In step S120, the CPU 11, as the motion abnormality determination model learning unit 26, calculates a gradient from the obtained loss and updates the weight of the motion abnormality determination model by back propagation.

In step S122, the CPU 11, as the motion abnormality determination model learning unit 26, determines whether the loss is sufficiently small. In a case where the loss is not sufficiently small, the CPU 11 returns to step S112. On the other hand, in a case where the loss is sufficiently small, the CPU 11 proceeds to step S124.

In step S124, the CPU 11 outputs the updated motion abnormality determination model as the motion abnormality determination model learning unit 26 and ends the processing.

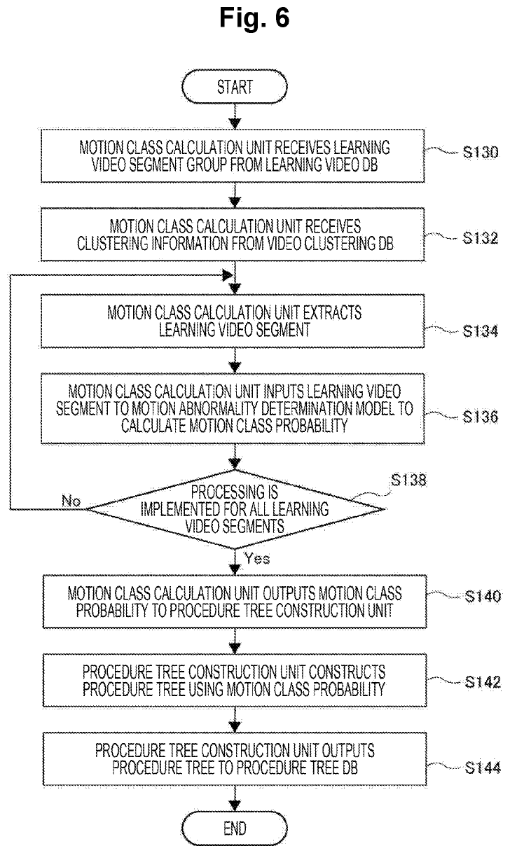

FIG. 6 is a flowchart illustrating a flow of procedure tree construction processing by the learning device 10. The CPU 11 reads out the learning program from the ROM 12 or the storage 14, develops the learning program in the RAM 13, and executes the learning program, whereby the procedure tree construction processing is performed. The procedure tree construction processing is processing of constructing a procedure tree by the method described in Non Patent Literature 2.

Non Patent Literature 2: S. Qi et al. Generalized Earley Parser: Bridging Symbolic Grammars and Sequence Data for Future Prediction. ICML2018.

In Non Patent Literature 2, it is assumed that the class probability is obtained for each frame, but in the present embodiment, the motion class probability is changed and applied so as to be calculated for each segment.

In step S130, the CPU 11 receives the learning video segment group from the learning video database 20 as the motion class calculation unit 28.

In step S132, the CPU 11 receives the clustering information from the clustering database 24 as the motion class calculation unit 28.

In step S134, the CPU 11 extracts the learning video segment from the learning video segment group as the motion class calculation unit 28.

In step S136, the CPU 11 inputs the learning video segment to the motion abnormality determination model as the motion class calculation unit 28 to calculate the motion class probability.

In step S138, the CPU 11 determines, as the motion class calculation unit 28, whether steps S134 and S136 have been implemented for all the learning video segments. In a case where there is the learning video segment for which steps S134 and S136 are not performed, the CPU 11 returns to step S134 and repeats the processing for the learning video segment. On the other hand, in a case where steps S134 and S136 are performed for all the learning video segments, the CPU 11 proceeds to step S140.

In step S140, the CPU 11 outputs the motion class probability of each learning video segment to the procedure tree construction unit 30 as the motion class calculation unit 28.

In step S142, the CPU 11 constructs a procedure tree using the motion class probability of each learning video segment as the procedure tree construction unit 30.

In step S144, the CPU 11 stores the procedure tree in the procedure tree database 32 as the procedure tree construction unit 30.

### Operation of Abnormality Determination Device According to First Embodiment

Next, the operation of the abnormality determination device 50 according to the first embodiment will be described.

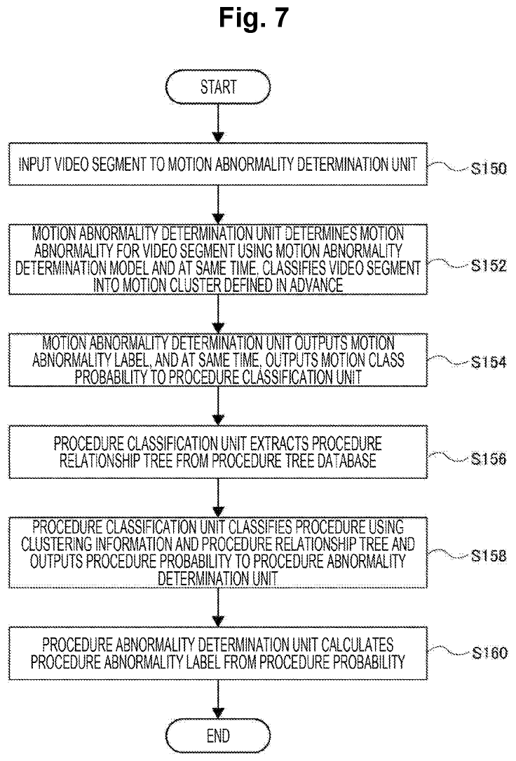

FIG. 7 is a flowchart illustrating a flow of abnormality determination processing by the abnormality determination device 50. The abnormality determination processing is performed by the CPU 11 reading the abnormality determination program from the ROM 12 or the storage 14, and loading and executing the abnormality determination program in the RAM 13. In addition, video data representing a motion of a person is input to the abnormality determination device 50.

In step S150, the CPU 11 inputs each video segment of the video data to the motion abnormality determination unit 62.

In step S152, as the motion abnormality determination unit 62, the CPU 11 determines a motion abnormality for each video segment using the motion abnormality determination model and at the same time, classifies the video segment into a motion cluster.

In step S154, as the motion abnormality determination unit 62, the CPU 11 outputs the motion abnormality label for each video segment output from the motion abnormality determination model by the display unit 16, and at the same time, outputs the motion class probability to the procedure classification unit 66.

In step S156, as the procedure classification unit 66, the CPU 11 extracts a procedure tree from the procedure tree database 64.

In step S158, as the procedure classification unit 66, the CPU 11 classifies the procedure using the motion class probability and the procedure tree for each video segment, and outputs the procedure probability to the procedure abnormality determination unit 68.

In step S160, as the procedure abnormality determination unit 68, the CPU 11 calculates a procedure abnormality label from the procedure probability for each video segment, and ends the abnormality determination processing.

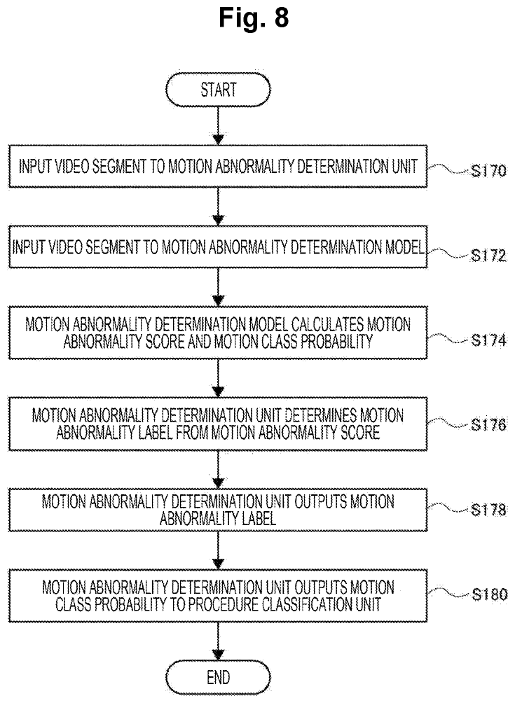

FIG. 8 illustrates detailed motions in the processing of steps S150 to S154. The motion illustrated in FIG. 8 is repeatedly performed for each video segment.

In step S170, the CPU 11 inputs the video segment to the motion abnormality determination unit 62.

In step S172, the CPU 11 inputs the video segment to the motion abnormality determination model as the motion abnormality determination unit 62. Here, the motion abnormality determination model is a classification model such as a neural network. Specifically, a neural network configured to perform softmax output for outputting a K-dimensional vector presenting a motion class probability that is a belonging probability of K motion clusters for classification and sigmoid output for outputting a motion abnormality score having a value from 0 to 1 is used as a motion abnormality determination model.

In step S174, the CPU 11 calculates the motion abnormality score and the motion class probability using the motion abnormality determination model as the motion abnormality determination unit 62.

In step S176, the CPU 11 determines a motion abnormality label from the motion abnormality score as the motion abnormality determination unit 62. The motion abnormality label is obtained by determining whether the motion abnormality score is abnormal or normal by comparing the motion abnormality score with a specific threshold value (for example, 0.5).

In step S178, the CPU 11 outputs a motion abnormality label as the motion abnormality determination unit 62.

In step S180, the CPU 11 outputs the motion class probability to the procedure classification unit 66 as the motion abnormality determination unit 62.

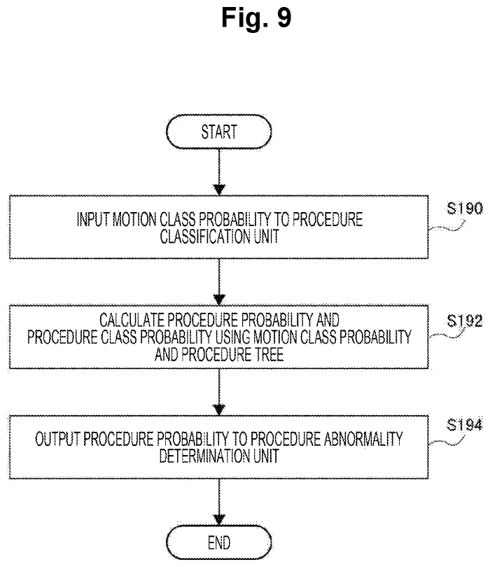

FIG. 9 illustrates detailed motions in the processing of steps S156 and S158. The motion illustrated in FIG. 9 is repeatedly performed for each video segment.

In step S190, the CPU 11 inputs the motion class probability to the procedure classification unit 66. Here, the procedure classification unit 66 holds the motion class probability (motion class probability at each time until time t−1) of each video segment from the start of the video, and calculates the procedure probability using the past motion class probability and the motion class probability at time t. Here, assuming that there are L procedures, the procedure probability indicates which procedure class of the L procedures corresponds to the procedure probability. Specifically, the procedure and the procedure probability are calculated by the method described in Non Patent Literature 2.

In step S192, as the procedure classification unit 66, the CPU 11 calculates the procedure probability at the time t using the motion class probability and the procedure tree, and obtains a procedure class indicating which procedure the motion at the time t is classified into.

In step S194, as the procedure classification unit 66, the CPU 11 outputs the procedure probability and the procedure class at time t−1 and time t and the procedure probability and the procedure class at time t+1 predicted from the procedure tree to the procedure abnormality determination unit 68.

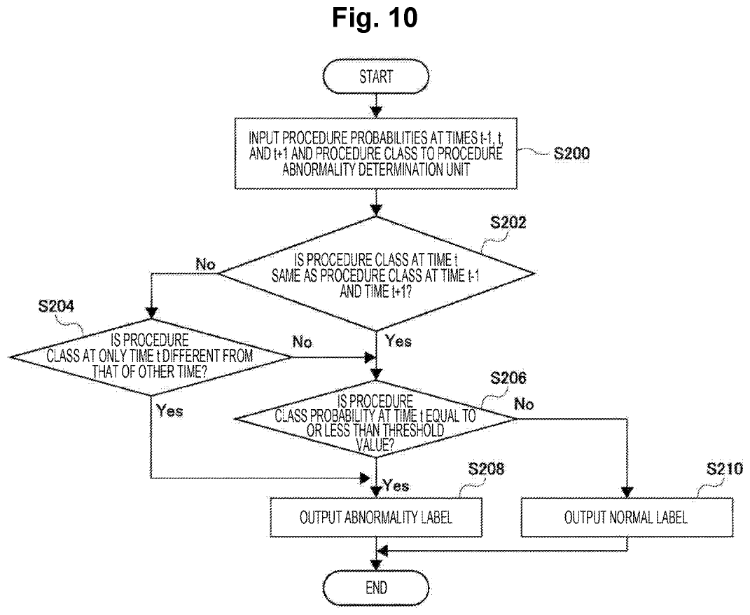

FIG. 10 illustrates a detailed motion in the processing of step S160. The motion illustrated in FIG. 10 is repeatedly performed for each video segment.

In step S200, the CPU 11 inputs the procedure probability and the procedure class at the time t to the procedure abnormality determination unit 68.

In step S202, as the procedure abnormality determination unit 68, the CPU 11 determines whether the procedure class at the time t is the same as the procedure class at the time t−1 and the time t+1. In a case where the procedure class at the time t is the same as the procedure class at the time t−1 and the time t+1, the CPU 11 proceeds to step S206. On the other hand, in a case where the procedure class at the time t is not the same as the procedure class at the time t−1 and the time t+1, the CPU 11 proceeds to step S204. In a case where the procedure classes at the time t−1 and the time t+1 are not the same, the CPU 11 proceeds to step S206.

In step S204, as the procedure abnormality determination unit 68, the CPU 11 determines whether the procedure classes at only the time t are different. In a case where the procedure classes are the same at the time t−1 and the time t+1 and the procedure classes are different only at the time t, the CPU 11 proceeds to step S208.

On the other hand, in step S206, the CPU 11, as the procedure abnormality determination unit 68, determines whether the procedure probability of the procedure class at the time t is equal to or less than the threshold value. In a case where the procedure probability of the procedure class at the time t is equal to or less than the threshold value, the CPU 11 proceeds to step S208. On the other hand, in a case where the procedure probability of the procedure class at the time t is larger than the threshold value, the CPU 11 proceeds to step S210.

In step S208, the CPU 11 outputs a procedure abnormality label indicating that the procedure is abnormal as the procedure abnormality determination unit 68 and ends the processing. In step S210, the CPU 11 outputs a procedure abnormality label indicating that the procedure is normal as the procedure abnormality determination unit 68 and ends the processing.

As described above, the abnormality determination device according to the first embodiment classifies the video data representing the motion of the person into the motion cluster, determines whether the motion of the person is abnormal, classifies the motion of the person into the procedures based on the classification result of the motion clusters and the procedure tree, and determines whether the procedure including the motion of the person is abnormal based on the classification result of the procedure. As a result, it is possible to accurately determine abnormality of a procedure and abnormality of a motion itself.

In addition, by expressing a relationship between a procedure and a motion by a perspective tree, it is possible to simultaneously detect a procedure representing at least one motion and an abnormality of the motion. In addition, it is possible to detect an abnormal action in a procedure unit that can be integrated in a certain section of a captured video of a certain work.

### Second Embodiment

Next, a second embodiment will be described. Note that parts having configurations similar to those of the first embodiment are denoted by the same reference numerals, and description thereof is omitted.

The second embodiment is different from the first embodiment in that a motion class probability that is a K-dimensional vector is converted into an L-dimensional vector and classified into a procedure.

### Overview of Second Embodiment

Considering the time t, the procedure tree can be changed to a converter that converts a K-dimensional vector that is the motion class probability into an L-dimensional vector. For example, a method of converting into an L-dimensional vector using the converter of Non Patent Literature 3 can be used.

Non Patent Literature 3: A. Vaswani et al. Attention is All you Need. NeurIPS2017.

At that time, it is necessary to prepare L procedure classes in advance so that the procedure classes can be classified. Specifically, a cluster method such as k-means is performed in advance so that a K-dimensional vector representing the motion class probability can be classified into L procedure classes, and L center vectors are obtained as procedure classes. However, in this case, it is necessary to separately consider the time t−1 and the time t+1. Specifically, the converter is configured to include a network that outputs an L-dimensional vector at time t with both a K-dimensional vector that is a motion class probability at time t−1 and a K-dimensional vector that is a motion class probability at time t as inputs, and a network that outputs an L-dimensional vector at time t+1 with the L-dimensional vector at time t−1 and the L-dimensional vector at time t as inputs.

In the procedure tree of the first embodiment, the motion class probability from the time 0 to the time t can be used as an input, but in the converter of the second embodiment, the motion class probability of only the peripheral time is used as an input. Therefore, as in Non Patent Literature 4, longer term context information may be input to the converter using a long short-term memory (LSTM) or the like.

Non Patent Literature 4: S. Hochreiter and J. Schmidhuber. Long Short-Term Memory. Neural Computation, volume 9, 1997.

### Configuration of Learning Device According to Second Embodiment

Since the learning device of the second embodiment is similar to the learning device 10 of the first embodiment, the same reference numerals are applied and description thereof is omitted.

The procedure tree construction unit 30 of the learning device 10 constructs, as a procedure tree, a converter that converts the motion class probability, which is a K-dimensional vector, into an L-dimensional vector based on the motion class probability for each learning video segment.

Specifically, a converter that obtains center vectors of L procedure classes by a clustering method based on the motion class probability for each learning video segment and converts the motion class probability, which is a K-dimensional vector, into an L-dimensional vector is constructed as a procedure tree.

### Configuration of Abnormality Determination Device According to Second Embodiment

Since the abnormality determination device of the second embodiment is similar to the abnormality determination device 50 of the first embodiment, the same reference numerals are given and the description thereof will be omitted.

The procedure classification unit 66 of the abnormality determination device 50 converts the motion class probability, which is a K-dimensional vector, into a procedure probability, which is an L-dimensional vector, using a converter, which is a procedure tree constructed by the learning device 10.

Note that other configurations and operations of the learning device 10 and the abnormality determination device 50 according to the second embodiment are similar to those of the first embodiment, and thus description thereof is omitted.

### Modification Examples

Note that the present invention is not limited to the above-described embodiments, and various modifications and applications can be made without departing from the gist of the present invention.

For example, a case where the learning device and the abnormality determination device are configured as separate devices has been described as an example, but the present invention is not limited thereto, and the learning device and the abnormality determination device may be configured as one device.

In addition, various processes executed by the CPU reading software (program) in each of the above embodiments may be executed by various processors other than the CPU. Examples of the processors in this case include a graphics processing unit (GPU), a programmable logic device (PLD) whose circuit configuration can be changed after the manufacturing, such as a field-programmable gate array (FPGA), and a dedicated electric circuit that is a processor having a circuit configuration exclusively designed for executing specific processing, such as an application specific integrated circuit (ASIC). Furthermore, the learning processing and the abnormality determination processing may be executed by one of these various processors, or may be performed by a combination of two or more processors of the same type or different types (for example, a plurality of FPGAs, a combination of a CPU and an FPGA, and the like). More specifically, a hardware structure of the various processors is an electric circuit in which circuit elements such as semiconductor elements are combined.

Furthermore, in the above embodiments, the aspect in which the learning program and the abnormality determination program are stored (installed) in advance in the storage 14 has been described, but the present invention is not limited thereto. The program may be provided in the form of a program stored in a non-transitory storage medium such as a compact disk read only memory (CD-ROM), a digital versatile disk read only memory (DVD-ROM), or a universal serial bus (USB) memory. The program may be downloaded from an external device via a network.

With regard to above embodiment, the following supplementary items are further disclosed.

### Supplementary Item 1

An abnormality determination device including a clustering database that stores a plurality of motion clusters related to a motion of a person based on features of video data,

a procedure tree database that stores a procedure tree representing a relationship between a plurality of procedures including at least one motion, the procedure tree storing the motion clusters for each of the plurality of procedures,

a memory, and

at least one processor connected to the memory, in which

the processor classifies video data representing a motion of a person into the motion clusters and determines whether the motion of the person is abnormal,

classifies the motion of the person into the procedures based on classification results of the motion clusters and the procedure tree, and

determines whether the procedure including the motion of the person is abnormal based on classification results of the procedure.

### Supplementary Item 2

A non-transitory storage medium storing a program that can be executed by a computer including

a clustering database that stores a plurality of motion clusters related to a motion of a person based on features of video data and

a procedure tree database that stores a procedure tree indicating a relationship between a plurality of procedures including at least one motion, the procedure tree storing the motion clusters for each of the plurality of procedures to execute abnormality determination processing, in which

the abnormality determination processing includes

classifying video data representing a motion of a person into the motion clusters and determining whether the motion of the person is abnormal,

classifying the motion of the person into the procedures based on the classification result of the motion clusters and the procedure tree, and

determining whether the procedure including the motion of the person is abnormal based on classification results of the procedure.

### REFERENCE SIGNS LIST

10 Learning device
11 CPU
14 Storage
15 Input unit
16 Display unit
20 Learning video database
22 Clustering unit
24, 60 Clustering database
26 Motion abnormality determination model learning unit
28 Motion class calculation unit
30 Procedure tree construction unit
32, 64 Procedure tree database
50 Abnormality determination device
62 Motion abnormality determination unit
66 Procedure classification unit
68 Procedure abnormality determination unit

1. An abnormality determination device comprising a processor configured to execute operations comprising:
storing, in a first clustering database, a plurality of motion clusters related to a motion of a person based on features of video data;
storing, in a second database, a procedure tree representing a relationship between a plurality of procedures including at least one motion, the procedure tree storing a motion cluster for each of the plurality of procedures;
classifying the video data representing a motion of a person into the motion cluster;
determining whether the motion of the person is abnormal;
classifying the motion of the person into the plurality of procedures based on classification results of the motion cluster and the procedure tree; and
determining whether a procedure of the plurality of procedures including the motion of the person is abnormal based on classification results of the procedure of the plurality of procedures.

2. The abnormality determination device according to claim 1, wherein
the classifying the video data further comprises classifying the video data into the motion cluster;
the determining whether the motion of the person is abnormal further comprises determining whether the motion of the person is abnormal at each time,
the classifying the motion of the person further comprises classifying the motion of the person into the procedures for each time, and
the determining whether the procedure of the plurality of procedures including the motion of the person is abnormal further comprises determining whether the procedure of the plurality of procedures is abnormal based on classification results of the procedure of the plurality of procedures at each time.

3. The abnormality determination device according to claim 1, wherein
the classifying video data further comprises calculating a motion class probability, the motion probability represents a probability belonging to each of the plurality of motion clusters to classify the motion cluster, and
the procedure tree stores the motion class probability corresponding to each of the plurality of procedures.

4. The abnormality determination device according to claim 3, wherein
the plurality of motion clusters includes K motion clusters, the K being an integer,
the plurality of procedures includes L procedures, the L being an integer, and
the procedure tree is a converter that converts the motion class probability that is a K-dimensional vector into an L-dimensional vector, and
the classifying the motion of the person further comprises converting the motion class probability, the motion class probability includes a K-dimensional vector into an L-dimensional vector using the procedure tree to classify the procedures.

5. A computer implemented method for determining abnormality, comprising:
storing, in a first database, a plurality of motion clusters related to a motion of a person based on features of video data
storing, in a second database, a procedure tree representing a relationship between a plurality of procedures including at least one motion, the procedure tree storing the motion clusters for each of the plurality of procedures;
classifying video data representing a motion of a person into the motion clusters;
determining whether the motion of the person is abnormal;
classifying the motion of the person into the procedures based on classification results of the motion clusters and the procedure tree; and
determining whether the procedure including the motion of the person is abnormal based on classification results of the procedure.

6. A computer-readable non-transitory recording medium storing a computer-executable program instructions that when executed by a processor cause a computer to execute operations comprising:
storing, in a first database, a plurality of motion clusters related to a motion of a person based on features of video data;
storing, in a second database, a procedure tree representing a relationship between a plurality of procedures including at least one motion, the procedure tree storing the motion clusters for each of the plurality of procedures;
classifying video data representing a motion of a person into the motion clusters;
determining whether the motion of the person is abnormal;
classifying the motion of the person into the procedures based on classification results of the motion clusters and the procedure tree; and
determining whether the procedure including the motion of the person is abnormal based on classification results of the procedure.

7. The abnormality determination device according to claim 1, wherein a procedure of the plurality of procedures includes the motion of the person.

8. The abnormality determination device according to claim 1, wherein the first database includes a clustering database, and the clustering database stores a center vector of a feature vector of the motion cluster.

9. The abnormality determination device according to claim 1, wherein the second database includes a procedure tree database, the procedure tree stores a plurality of procedure trees.

10. The computer implemented method according to claim 5, wherein
the classifying the video data further comprises classifying the video data into the motion cluster;
the determining whether the motion of the person is abnormal further comprises determining whether the motion of the person is abnormal at each time,
the classifying the motion of the person further comprises classifying the motion of the person into the procedures for each time, and
the determining whether the procedure of the plurality of procedures including the motion of the person is abnormal further comprises determining whether the procedure of the plurality of procedures is abnormal based on classification results of the procedure of the plurality of procedures at each time.

11. The computer implemented method according to claim 5, wherein
the classifying video data further comprises calculating a motion class probability, the motion probability represents a probability belonging to each of the plurality of motion clusters to classify the motion cluster, and
the procedure tree stores the motion class probability corresponding to each of the plurality of procedures.

12. The computer implemented method according to claim 11, wherein
the plurality of motion clusters includes K motion clusters, the K being an integer,
the plurality of procedures includes L procedures, the L being an integer, and
the procedure tree is a converter that converts the motion class probability that is a K-dimensional vector into an L-dimensional vector, and
the classifying the motion of the person further comprises converting the motion class probability, the motion class probability includes a K-dimensional vector into an L-dimensional vector using the procedure tree to classify the procedures.

13. The computer implemented method according to claim 5, wherein a procedure of the plurality of procedures includes the motion of the person.

14. The computer implemented method according to claim 5, wherein the first database includes a clustering database, and the clustering database stores a center vector of a feature vector of the motion cluster.

15. The computer implemented method according to claim 5, wherein the second database includes a procedure tree database, the procedure tree stores a plurality of procedure trees.

16. The computer-readable non-transitory recording medium according to claim 6, wherein
the classifying the video data further comprises classifying the video data into the motion cluster;
the determining whether the motion of the person is abnormal further comprises determining whether the motion of the person is abnormal at each time,
the classifying the motion of the person further comprises classifying the motion of the person into the procedures for each time, and
the determining whether the procedure of the plurality of procedures including the motion of the person is abnormal further comprises determining whether the procedure of the plurality of procedures is abnormal based on classification results of the procedure of the plurality of procedures at each time.

17. The computer-readable non-transitory recording medium according to claim 6, wherein
the classifying video data further comprises calculating a motion class probability, the motion probability represents a probability belonging to each of the plurality of motion clusters to classify the motion cluster, and
the procedure tree stores the motion class probability corresponding to each of the plurality of procedures.

18. The computer-readable non-transitory recording medium according to claim 17, wherein
the plurality of motion clusters includes K motion clusters, the K being an integer,
the plurality of procedures includes L procedures, the L being an integer, and
the procedure tree is a converter that converts the motion class probability that is a K-dimensional vector into an L-dimensional vector, and
the classifying the motion of the person further comprises converting the motion class probability, the motion class probability includes a K-dimensional vector into an L-dimensional vector using the procedure tree to classify the procedures.

19. The computer-readable non-transitory recording medium according to claim 6, wherein a procedure of the plurality of procedures includes the motion of the person.

20. The computer-readable non-transitory recording medium according to claim 6, wherein the first database includes a clustering database, and the clustering database stores a center vector of a feature vector of the motion cluster.
